(19) United States
(12) Patent Application Publication
(10) Pub. No.: US 2015/0233519 A1
(43) Pub. Date: Aug. 20, 2015

(54) THERMALLY INSULATED PANEL

(71) Applicant: Kenneth Teasdale, Temecula, CA (US)

(72) Inventor: Kenneth Teasdale, Temecula, CA (US)

(21) Appl. No.: 14/181,605

(22) Filed: Feb. 14, 2014

(51) Int. Cl. F16L 59/065; B32B 3/08; B32B 3/04; E04B 1/80

(52) U.S. Cl. CPC F16L 59/065; E04B 1/803; B32B 3/085; B32B 3/04; B32B 2607/00; B32B 2307/304

(57) ABSTRACT

A thermally insulative sealed hollow panel with significantly improved thermal resistance, comprising inner and outer plates spaced apart by helically coiled springs, and at least one layer of low thermal emissivity foil supported by crisscrossing wires anchored at points along the perimeter edge of the inner plate.

### FIELD OF THE INVENTION

The present invention relates to thermal insulation, more particularly to vacuum insulated panels.

### BACKGROUND

Thermal barriers are physical structures that are designed to greatly impede the flow of heat from the high temperature side to the low temperature side. There are three primary mechanisms that allow heat to migrate; conduction, convection, and radiation. Conduction, convection, and radiation occur simultaneously; i.e. they occur in parallel, allowing heat to transfer along three different routes at once. A good thermal barrier will inhibit all three of these mechanisms. The greater the inhibition, the higher the classification of the thermal barrier. This classification is known as the R-value, or resistance value. Under uniform conditions this is calculated as the ratio of the temperature difference across an insulator and the heat transfer per unit area per unit time. In the United States, the customary units for R-value are BTU/(h ° F. ft²).

There are different materials known for their insulation properties. The construction industry prefers glass-fiber batting, loose fill, rigid foam, and foam-in-place. These are good insulators and are relatively inexpensive, but generally do not have an R-value greater than 49. In addition, these higher R-value products require large thicknesses to achieve good insulation. For example, to achieve an R-value of 49 with fiberglass batting, it must be nearly 16 inches thick, which is too thick for general construction needs. Thus, there has been a long-standing need for a lightweight, thin, highly insulative panel with very large R-values. In view of the above, the below description provides examples of panels that address the deficiencies of the prior art as well as provide in some instances, R-values approaching 100 or more.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In one aspect of various exemplary embodiments, a thermally insulative sealed hollow panel is provided, the panel comprising: a first plate disposed adjacent to a substantially parallel second plate; a plurality of helically coiled springs with axes of compression that are substantially perpendicular to the plates and disposed therebetween, said axes being substantially equidistant from each other; at least one layer of a low thermal emissivity film disposed between the plates and substantially parallel thereto, wherein the film engages the plurality of springs; and a flexible perimeter edge membrane joined to at least one perimeter edge of the first plate and at least one perimeter edge of the second plate, thereby forming a closed cavity with a pressure between 0 and 1 atm.

In one aspect of various exemplary embodiments, a thermally insulative sealed hollow panel is provided, the panel comprising: a support structure comprising, a first frame disposed adjacent to a substantially parallel second frame, each frame having at least one perimeter member and a plurality of cross members, a plurality of helically coiled springs with axes of compression that are substantially perpendicular to the frames with the springs disposed therebetween, a plurality of guy wires, each guy wire having a first end and a second end, the first end being joined to the first plate and the second end being joined to the second plate, whereby the guy wires diagonally traverse a central region, and at least one layer of low thermal emissivity film disposed between the frames and substantially parallel thereto, wherein the film engages at least one of the plurality of springs; and an enclosure surrounding the support structure thereby creating a closed cavity with a pressure between 0 and 1 atm, wherein the enclosure is joined to the first frame and the second frame.

In one aspect of various exemplary embodiments, a thermally insulative sealed hollow panel is provided, the panel comprising: means for enclosing a vacuum sealable cavity, wherein the enclosing means comprise at least two substantially parallel sides and at least one flexible edge membrane; means for spacing the two sides; means for reducing radiative heat transfer between the two sides; means for supporting the radiative heat transfer reducing means; and means for anchoring the supporting means to the enclosing means, the anchoring means joined to at least one side of the enclosing means.

### BRIEF DESCRIPTION OF THE DRAWINGS

FIG. 1 is a perspective view with layered cross-section of an embodiment vacuum insulated panel.

FIG. 2 is a zoomed in view of a section of the panel shown in FIG. 1.

FIG. 3 is a top view of another embodiment vacuum insulated panel, showing an internal frame.

FIG. 4 is a zoomed in view of a section of the panel shown in FIG. 3.

FIG. 5 is a cross-section of another embodiment vacuum insulated panel.

FIG. 6 is a cross-section of still another embodiment vacuum insulated panel.

FIG. 7 is a top view of another embodiment vacuum insulated panel without the enclosure.

FIG. 8 is a sectioned, side view of the panel shown in FIG. 7.

FIG. 9 is a perspective view of an embodiment safety clasp.

### DETAILED DESCRIPTION

In the following detailed descriptions of various exemplary embodiments, reference is made to the accompanying drawings that form a part hereof, and in which is shown, by way of illustration, specific embodiments that may be practiced. It is to be understood that other embodiments may be utilized and structural changes may be made without departing from the scope of the present disclosure.

Another type of thermal barrier is a vacuum insulated panel (VIP). Generally, these panels are metal or plastic enclosures with sealed edges in order to evacuate most of the gaseous molecules from the interior of the enclosure. The reason for vacuum sealing an enclosure is because it greatly minimizes convective heat transfer between the high temperature side and the low temperature side. A perfect vacuum eliminates the convective transfer altogether. VIPs must have at least three sides (a cylinder); an internal side, an external side, and an edge side. The most practical configuration for use in construction and on most structures would have six sides (a flat rectangular box) wherein the interior side adjoins the structure. The internal side may be the high temperature side or the low temperature side, depending on the application. For instance, the VIP may be the insulator for a freezer or for a furnace.

There are three primary applications of this technology that will affect a significant improvement in the reduction of energy consumption. The first is a small, self-contained unit like a refrigerator or freezer. The second is heat storage applications as related to intermittent alternate energy storage in the form of a very hot medium. Excess energy produced during high peak periods can be stored in high temperature fluids and released through heat pumps during low energy generation. Resisting heat loss would add to the overall efficiency of such a system. The third, and perhaps for the more energy conservationist application, is to apply this technology to the construction of hyper-insulated buildings. The skeletal I-beam construction of buildings could be greatly improved, from an energy consumption perspective, by utilizing an external “skin” composed of a connected series of hyper-insulative panels created in the manner described herein. Such a structure would be very similar to current construction methods and yet, the heating ventilation and air-conditioning (HVAC) requirements would be reduced by at least two-thirds.

One drawback that has heretofore plagued VIPs is the spacers used for keeping the plates separated. Pressure inside the enclosure is reduced as air is evacuated from inside the enclosure and the sides collapse toward each other because atmospheric pressure, or external pressure, becomes greater than the internal pressure. If left unsupported, then the plates would fully collapse and thermally conduct thereby losing insulative ability. VIPs may counteract the compressive force of air through the use of a rigid, highly-porous material, such as foam, to support the enclosure. To improve the insulative value of a VIP, multiple layers of plastics or foam provide radiative baffles, but these layers still conduct heat. Cylindrical pins may be used as spacers to prevent plate compression and minimize conductive heat transfer, but any of these structural elements allow heat to freely conduct from one side of the panel to the other. In fact, quite substantially so. By way of example, a four-foot by eight-foot VIP with high stress stainless steel sides and enough 1 mm diameter pins of the same material to prevent the panel from collapsing under vacuum will yield an R-value of approximately 2.5. R-values of 50 per inch thickness, measured at the center of the panel, have been achieved with a rigid core VIP.

Engineering a VIP involves making numerous design trade-off decisions. For example, vacuum sealing greatly increases the R-value, but the sides must be supported to prevent collapse. In another example, 6AL-4V Titanium (Ti) has a very low thermal conductivity (6.70 W/m·K), but it is expensive, almost prohibitively so. Using low thermal conductivity material is a substantial component to the achievement of such a high R-value, but the largest contributing factor to achieving very large R-values is vacuum sealing the VIP. A vacuum seal may be defined as an internal pressure less than 1 atm at sea level, though, typically, vacuum sealing refers to an absence of matter (gas molecules) and connotes an internal pressure much less than 1 atm. For the purpose of this disclosure, vacuum pressure is essentially defined as any pressure obtained by a vacuum pump because, practically speaking, a perfect vacuum cannot be obtained. Vacuum pressure may also be referred to as negative pressure because pressure gauges are calibrated to measure atmospheric pressure as 0 psig and any pressure less than atmospheric would measure as a negative value. Partial filling may be defined as the total volume of gas being less than the total free volume inside the panel. Partial filling may also be defined as a pressure inside the panel of less than 1 atmosphere (atm) at sea level, but generally greater than 0.05 atm. Partial back-filling refers to creating a vacuum and then replacing some of the empty space with a gas.

To demonstrate the effectiveness that vacuum sealing a VIP has on the R-value, two identically constructed panels are compared; one with a vacuum seal and one without a vacuum seal. In an embodiment, a 1 square meter rectangular vacuum sealed panel comprised of 6AL-4V Ti sides, 6AL-4V Ti springs, 8 layers of polished copper foil having a thickness of 0.003-0.005 inches and with a thermal emissivity of 0.02, yields an R-value of approximately 174 in the center of the panel with an overall thickness of 1.678 inches (103.6 R per inch thickness). Compared to a panel with an air-filled interior, the R-value is calculated to be approximately 10.

However, a vacuum sealed interior is not required to achieve substantial R-values with a thin panel. For example, if, in the previous example, air were to be replaced with Xenon gas, then the calculated R-value would increase to approximately 48. Thus, a vacuum sealed panel at least partially back-filled with a low specific heat gas (cₚ≦0.60), such as Argon, Krypton, Xenon, and so forth, will yield acceptable R-values.

In another embodiment, titanium components of the previous vacuum sealed example are replaced with 316L sides, 17-7 stainless steel H900 temper springs, and consumer grade aluminum foil. This combination of materials yields a calculated R-value of 124 (73.9 per inch thickness) in the center of the panel.

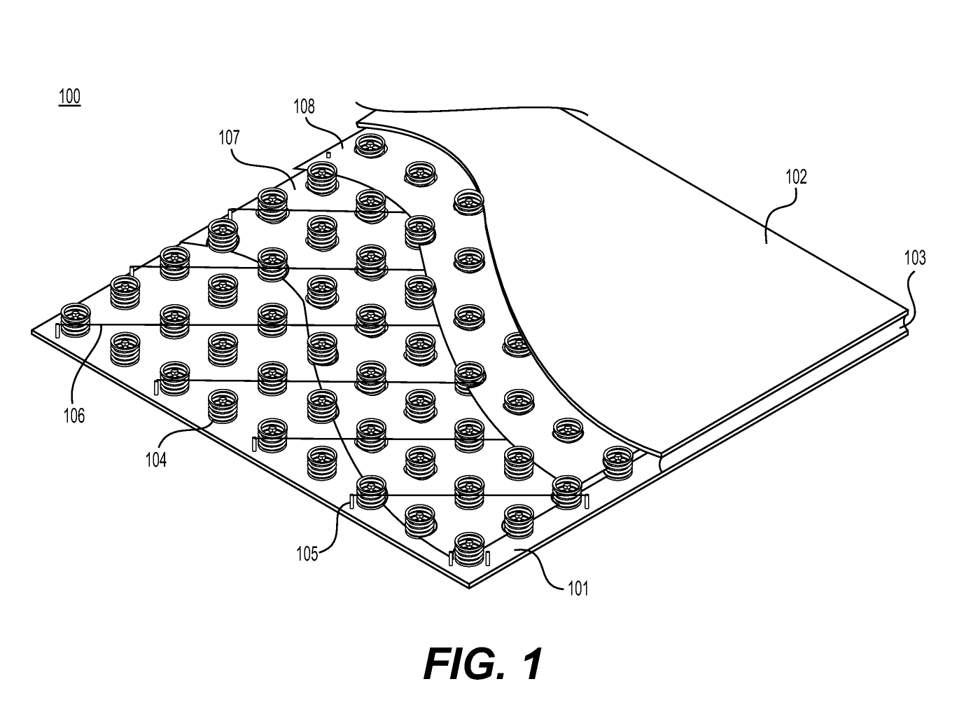

Turning now to the drawings, FIG. 1 is a perspective view with a layered cross-section of an embodiment vacuum insulated panel 100. Here, internal sections are cut in a curved shape to more easily illustrate how the layers interact. A person having ordinary skill in the art will appreciate that the exemplary embodiment VIP may include more, less, or different components than the ones illustrated, which are shown merely as one example. Therefore, modifications, changes, and different configurations may be made without departing from the spirit and scope of this disclosure. In an embodiment, the first layer 101, otherwise called a first panel or an internal panel, may support an end of the helically coiled compression springs 104. These springs 104 may act as spacers to displace the first and second panels 101, 102 apart. Theoretically, a perfect spacer for a VIP would be one that tapers at each end to an infinitesimally small point that contacts a surface of the first panel 101 and a surface of a second panel 102. However, in practice, a double-ended sharp pointed spacer will either pierce the panels 101, 102, thereby relieving internal vacuum, or cause the spacer tip to collapse under load because the tip would plastically deforms to a much broader point, thus defeating the effectiveness of a sharp pointed spacer.

Springs 104 surmount this problem two-fold. First, the springs 104 may support a large area between the first panel 101 and the second panel 102 upon vacuum sealing the panel 100. The supported area may, generally, be the outer diameter of the spring 104. Thus, a spring 104 may not puncture the panel 100 while under load because the force exerted by the panel 100 onto the spring 104 is spread over a much larger area. This force divided by area, or pressure, creates a stress manageable by most rigid materials' tensile strength, including many plastics or glass. Second, springs 104 are much more effective in preventing conductive heat transfer than other types of spacers because heat must conduct along the entire length of the spring coil. Heat flow rate via conduction is governed by Fourier's Law, or Q=−kAΔT/Δx, where Δx is the length of spring wire between the ends of the coil, ΔT is the temperature delta, A is the cross-sectional area of the coil's wire, and k is the thermal conductivity of the material. Thus, the R-value of a VIP increases as coil wire length increases, coil wire cross-sectional area decreases, and thermal conductivity decreases.

A spring may be manufactured in many varieties and its properties may be tailored for a specific application. For a panel 100 as shown in FIG. 1, a spring 104 may have a diameter larger than 1 inch, may have more than 5 coils, may have a coil diameter larger than 0.125 inch, may and be made from a low thermal conductivity metal such as 6AL-4V titanium, 17-7 H900 temper stainless steel, 316L stainless steel, and so forth. Thermal conductivity has units of W/m·K and a low value is generally considered to be less than 20. Metal may be required as a structural material for the enclosure 101, 102, 103 or the springs 104 because the load on an individual spring 104 may exceed 1000 lbf and metal, generally, can withstand higher stress before plastic deformation occurs. Although, using plastic does afford some advantages over a metal structure. First, plastics have a much lower thermal conductivity than most metals; usually less than 1 W/m·K. Second, plastics are much lighter than most metals and could significantly reduce the overall weight by 4 or 5 times. Third, a plastic cavity can be easily sealed under vacuum with a heat-weld process. Thus, plastic is envisioned as a substitute for the metal structure when certain functional application requirements are met. Such requirements may be, for example, the interior or exterior temperature to be insulated, the amount of pressure within the enclosure, the structural requirements of the building, and so forth. Yet another material option may be structural carbon fiber because it has a thermal conductivity through-the-thickness that ranges from 2 to 21 W/m·K, and has higher tensile strength than more metals.

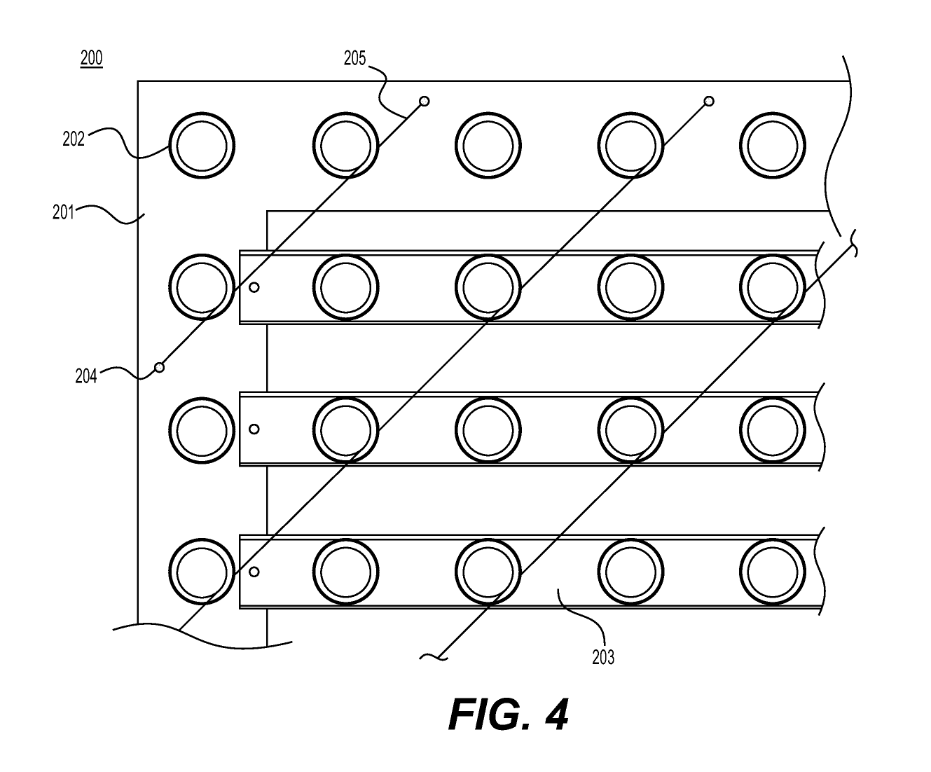

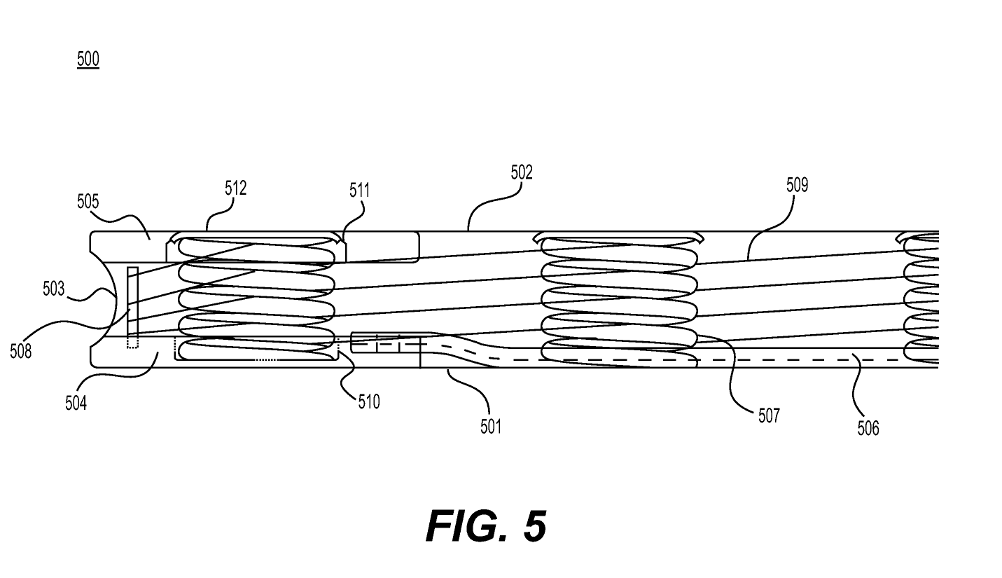

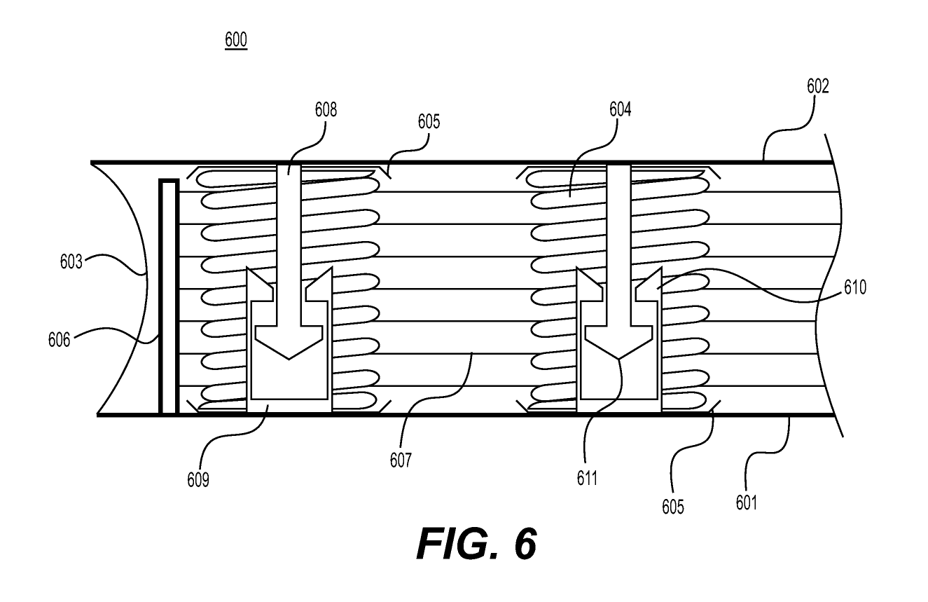

In an embodiment, springs 104 may have axes of compression substantially perpendicular to the plates 101, 102, said axes may be uniformly distributed between the plates 101, 102. Uniform distribution of springs 104 may have the effect of evenly dividing the load to each spring 104, said load created by reducing the internal pressure of the panel 100. Spacing between the springs' axes of compression may depend on manufacturing tolerance and techniques known to those skilled in the art. Spacing between the axes may be controlled during the manufacturing process by temporary fixtures. Spacing between the axes may be controlled by joining the springs 104 to the plates 101, 102 through welding, adhesives, tabs, or other joining means known to those skilled in the art. Spacing between the axes may be controlled by cups (see FIG. 5 or FIG. 6), grooves (see FIG. 4), bores (see FIG. 5), or other means known to those skilled in the art.

Returning to FIG. 1, in an embodiment, intermediate layers 107, 108 may be used to prevent radiative heat transfer. It is contemplated that there may be none, one, or more than one intermediate layers 107, 108 between the plates 101, 102. Intermediate layers 107, 108 may comprise low emissivity foil such as polished copper or silver (0.02-0.03), consumer grade aluminum foil (0.04), and so forth. Emissivity, a dimensionless quantity, is the value given to materials based on the ratio of heat emitted and absorbed compared to a blackbody, on a scale from zero to one. A blackbody would have an emissivity of 1 and a perfect reflector would have a value of 0. Low emissivity is widely considered to be less than 0.05. Thus, as the number of layers increase, the total radiative heat transfer between the plates 101, 102 decreases exponentially because a high percentage of the heat is emitted back toward the heat source at each successive layer. Emissivity of the plates 101, 102 themselves may also be lowered by polishing the interior surfaces.

In an embodiment, the intermediate layers 107, 108 may be disposed onto support wires 106, which may be attached to anchors 105, shown here, for example, as being disposed along the perimeter. In this manner, the support wires 106 may be placed in tension as the wire 106 spans a central region of the plates 101, 102. A support wire 106 may be one continuous wire, or a plurality of wires that separately engage anchors 105 on opposite sides of the perimeter of the plates 101, 102. A continuous support wire 106 may be woven around the perimeter anchors 105 and crisscross the central region of the plates 101, 102. Where a plurality of support wires 106 are used, an embodiment would comprise support wires 106 supported by at least two anchors 105. In addition, the support wire 106 may engage one or more spring 104 coils as the wire 106 traverses a central region of the plates 101, 102, which may provide further support for the wire 106.

In an embodiment, the intermediate layers 107, 108 may be joined to the support wire 106 though welding, adhesive, staples, and so forth.

In an embodiment, the anchors 105 may be cylindrical pins, square posts, trapezoidal braces, and so forth attached to a plate 101 or 102 via welding, pinning, bracing or other attachment means known to those skilled in the art. In this fashion, the anchors 105 may be cantilevered from the plate 101 or 102. In order to minimize conduction and to improve the R-value, an anchor 105, if mounted to plate 101, may not be in thermal contact with plate 102. Alternatively, an anchor 105, if mounted on plate 102, may not be in thermal contact with plate 101.

In an embodiment, plates 101, 102 may be substantially parallel yet have acceptable misalignment due to manufacturing tolerances and techniques known to those skilled in the art. It is understood that the adjective substantially is a term of art, to connote approximate or principally having the shape, direction, form, etc., of the item being modified by the adjective. Accordingly, substantially inherently provides a degree of reasonable flexibility, in appearance and/or function, to the term/item being modified and should be interpreted in the context of its use according to one of ordinary skill in the art.

Further, when viewed from a side, plates 101, 102 may not appear completely flat as they may bow away from each other, where the bow may be caused by the springs exerting force to separate the plates 101, 102. The bow may also be caused by the panel's internal pressure being lower than atmospheric pressure, which may cause the plates 101, 102 to bow toward each other. Localized bowing of the plates 101, 102 may also be visible where the spring 104 engages the plate given the amount of load, type of material, and thickness of plate 101, 102 material.

In an embodiment, the shape of the plates 101, 102 are rectangular and approximately the same size, though it is contemplated that nearly any shape is feasible to manufacture, such as a square, triangle, circle, polygon, and so forth. Plates 101, 102 may have acceptable size differences given manufacturing tolerances and techniques known to those skilled in the art.

In an embodiment, a plate 101 may have a larger perimeter than plate 102 and vice versa. A larger perimeter may create an additional area, wherein this additional area may act as a flange that facilitates construction techniques, such as attaching to a stud wall, hanging onto I-beams, and so forth.

In an embodiment, an edge sealing membrane 103 is joined to the plates 101, 102 to create a sealed, hollow cavity. Joining the membrane 103 to the plates may occur through manufacturing processes known to those skilled in the art such as welding, adhesives, o-rings, RTV sealants, and so forth. The membrane 103 may have a small cross-sectional area to minimize heat transfer via conduction through the membrane. In the case of a thin membrane 103, the edge membrane 103 may be flexible, and may have a radius of curvature flexing inward toward the closed cavity, or bulging outward away from the closed cavity, to accommodate spacing variation between the plates 101, 102. Spacing variation may be inherent in the manufacturing process or may be caused by pressure fluctuations within the closed cavity, particularly if the closed cavity is partially filled with gas. Spacing may also be affected by atmospheric pressure fluctuation. Pressure may fluctuate as gas temperature increases or decreases, following the ideal gas law of thermodynamics, PV=nRT. Thus, the membrane 103 may assume a concave or convex shape as viewed from a side perspective.

In an embodiment, the membrane 103 may be made of a low thermal conductivity material such as 6AL-4V titanium, 17-7 H900 temper stainless steel, 316L stainless steel, plastic, carbon fiber, and so forth.

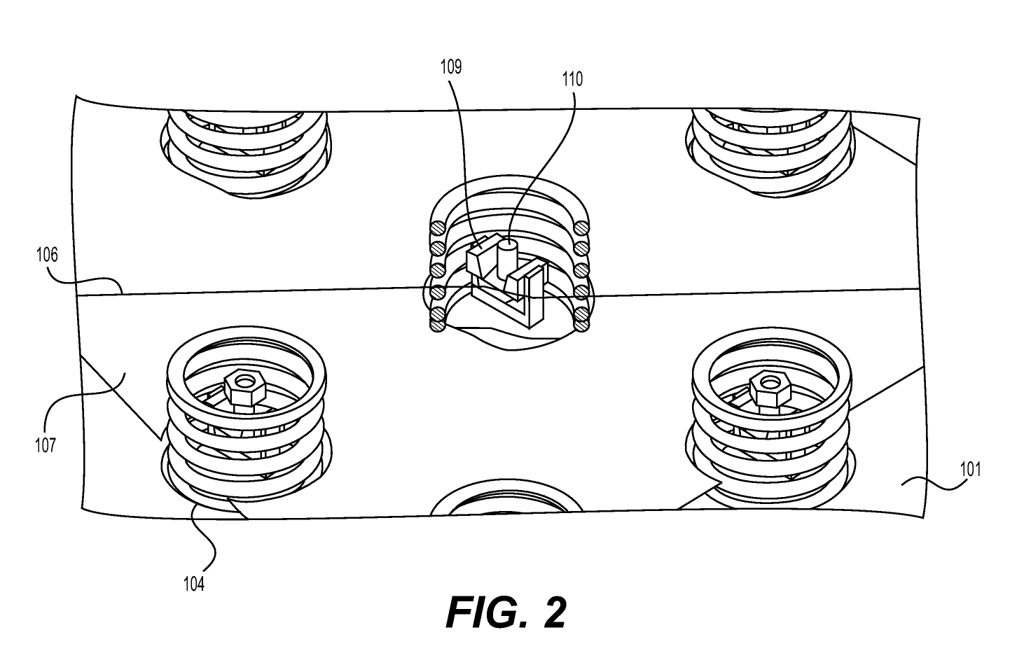

FIG. 2 is a zoomed in view of a section of the panel shown in FIG. 1. In an embodiment, a plurality of safety clasps 109, 110 may be used to capture and control spacing between the adjacent plates 101, 102. A panel 100 embodied with springs 104 and a closed cavity at less than atmospheric pressure may contain potential energy in each compressed spring 104. If the closed cavity of a panel 100 ruptures, then the safety clasps 109, 110 would restrict separation of the plates 101, 102. Safety clasps 109, 110 may comprise a clasp plug 110 and a clasp receptacle 109, whereby the clasp plug 110 may be joined to the second plate 102 and the clasp receptacle 109 may be joined to the first plate 101, or vice versa. The safety clasps 109, 110 may be joined to the plates 101, 102 through welding, adhesive, forceful press, or other joining means known to those skilled in the art.

In an embodiment, the safety clasps 109, 110 may not be in thermal communication in order to improve R-value. Reducing pressure inside the panel's closed cavity, typically performed during the manufacturing process, may cause the plates 101, 102 to move toward each other, thereby causing the clasp plug 110 and clasp receptacle 109 to thermally disengage. The clasp plug may limit the travel of the plates 101, 102 to prevent over-deflection, to prevent the springs 104 from reaching their solid height, and so forth.

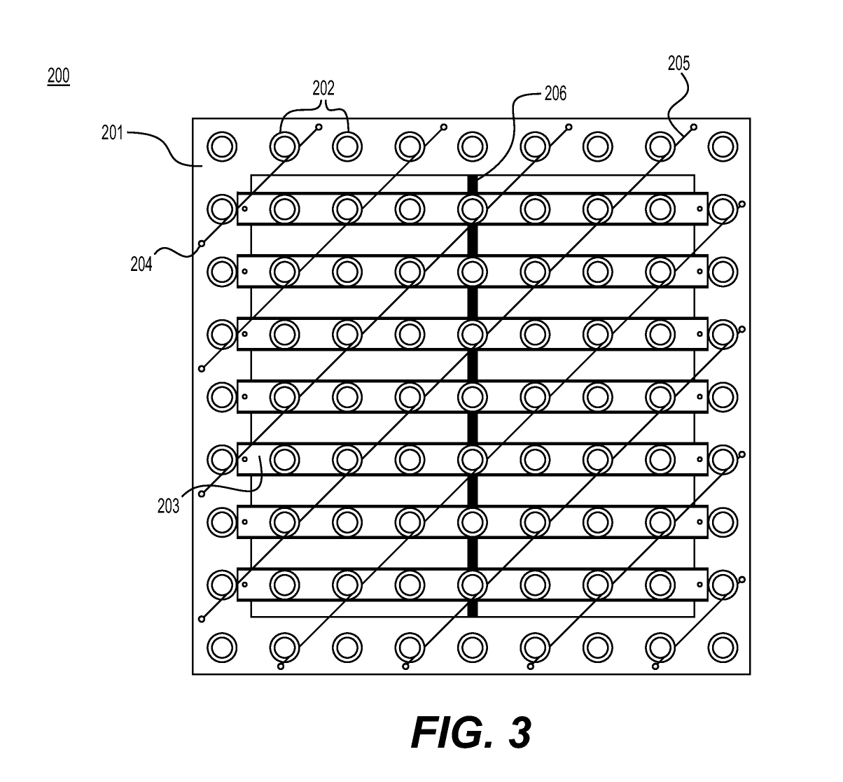

Turning now to FIG. 3, a top view of another embodiment vacuum insulated panel, showing an internal frame 200 is illustrated. The panel enclosure is not shown for clarity, but may be joined to the frame 200 through welding, adhesives, screws, or other joining means known to those skilled in the art. The frame 200 may be comprised of a first perimeter member 201 and a second perimeter member (not shown), whereby the first 201 and second perimeter members are separated by springs 202. The perimeter members may comprise an entire plate, though overall VIP weight may be undesirable. The springs 202 may have axes of compression substantially perpendicular to the perimeter member 201, said axes may be evenly distributed between the perimeter member 201. As explained above, even distribution of springs 202 may have the effect of evenly dividing the load to each spring 202. Spacing between the springs' axes of compression and the perpendicularity may depend on manufacturing tolerance and techniques known to those skilled in the art. Spacing between the axes may be controlled during the manufacturing process by temporary fixtures. Spacing between the axes may be controlled by joining the springs 202 to the perimeter member 201 through welding, adhesives, tabs, or other joining means known to those skilled in the art. Spacing between the axes may be controlled by cups, grooves, bores, or other means known to those skilled in the art.

In an embodiment, the frame 200 may have a plurality of cross-members 203, 206, where the cross-members 203, 206 may be joined to the first perimeter member 201 through welding, adhesives, screws, pins, and so forth. The perimeter member 201 and plurality of cross-members 203, 206 may be formed from a single piece of material as in a stamping operation, laser-cut, water-jet, mold, casting, or other forming process known to those skilled in the art. The cross-members 203, 206 may support the springs 202 in the central/open region of the frame 200. Additionally, the cross-members 203, 206 may support the frame from lateral compressive or tensile forces.

In an embodiment, the frame 200 may only comprise a perimeter member 201. Springs 202 may only engage the plates which are not shown in FIG. 3 (see 101, 102 in FIG. 1).

In an embodiment, anchors 204 may be joined to the perimeter member 201 along the outer perimeter edge through welding, screws, pins, and so forth. Support wires 205 may be placed in tension as the wire spans a central region of the frame 200. The support wire 205 may be continuous or a plurality of wires that separately engage anchors 204 or may be woven around the perimeter anchors 204, and crisscross the central region of the frame 200. The support wire 205 may engage one or more spring coils 202 as the wire 205 traverses a central region of the frame 200, which may provide further support and thermal isolation for the wire 205.

In an embodiment, support wires 205 may engage anchors 204 at multiple points to create a plurality of planar layers. The planar layers of support wires 205 may be used as a support for intermediate layers (not shown in FIG. 3) of low thermal emissivity foil to reduce radiative heat transfer. The support wires 205 may not intersect with any other planar layers of support wires 205 to ensure thermal isolation between layers.

FIG. 4 is a zoomed in view of a panel section illustrated in FIG. 3. Support wires 205 are more easily shown to engage a spring 202 at one of the spring's coils. Through conduction, the temperature of the support wires 205 may be substantially equal to the temperature of the coil of the spring 202 to which it may be engaged.

FIG. 5 is a cross-section of another embodiment vacuum insulated panel 500. An enclosure creating a closed cavity may be comprised of a first plate 501, a second plate 502, and a perimeter edge membrane 503. A frame may be disposed within the enclosure between the plates 501, 502, wherein the frame may comprise a first frame and a second frame, the first and second frames may comprise a first perimeter member 504 and a second perimeter member 505, a plurality of cross-members 506, anchors 508, support wires 509, and springs 507. The perimeter members 504, 505 may comprise bores 510, 511 in which the springs 507 may be restrained from lateral translation in order to maintain equidistant spring axis spacing. The cross-members 506 may be joined to the first perimeter member 504 by welding, forming, pinning, screwing, and so forth. The cross-members 506 may have a jog to accommodate the joining means and provide support for the first plate 501 by being planar with the first perimeter member 504. In this fashion, the springs 507, when compressed, can exert force between the first and second frames and evenly distribute that force to the plates 501, 502.

In an embodiment, anchors 508 may be joined to the perimeter member 504 along the outer perimeter edge through welding, screws, pins, and so forth. Support wires 509 may be placed in tension as the wire 509 spans a central region of the panel 500. The support wire 509 may be continuous or comprise a plurality of wires that separately engage anchors 508, or may be woven and crisscross the central region of the panel 500. The support wire 509 may engage one or more spring coils 507 as the wire 509 traverses a central region of the panel 500. Engagement with a spring coil 507 may include wrapping the wire 509 around an outer portion of the spring coil 507.

Turning now to FIG. 6, a cross-section of still another embodiment vacuum insulated panel is illustrated. An enclosure creating a closed cavity may be comprised of a first plate 601, a second plate 602, and a flexible perimeter edge membrane 603. Springs 604 are disposed between the plates 601, 602 and displace the plates 601, 602 apart. The springs 604 may be restrained from lateral translation by spring cups 605 in order to maintain equidistant spring axis spacing. The spring cups 605 may be joined to the plates 601, 602 through welding, screws, pins, and so forth. Support wires 607 may be placed in tension as the wire 607 spans a central region of the panel 600. The support wire 607 may be continuous or comprise a plurality of wires that separately engage anchors 606, or may be woven and crisscross the central region of the panel 600. The support wire 607 may engage one or more spring coils as the wire 607 traverses a central region of the panel 600. Engagement with a spring coil may include wrapping the wire 607 around the spring coil's wire or through the coil itself.

In an embodiment, a plurality of safety clasps 608, 609 may be used to capture and control spacing between the adjacent plates 601, 602. Safety clasps 608, 609 may comprise a clasp plug 608 and a clasp receptacle 609, whereby the clasp plug 608 may be joined to the second plate 602 and the clasp receptacle 609 may be joined to the first plate 601. The safety clasps 608, 609 may be joined to the plates 601, 602 through welding, adhesive, forceful press, or other joining means known to those skilled in the art. The clasp plug 608 may engage the clasp receptacle by causing tabs 610 on the clasp receptacle 609 to elastically deform and splay apart, thereby allowing the plunger 611 of the clasp plug 608 to slide past the tabs 610.

In an embodiment, a plurality of safety clasps 608, 609 may be joined to the spring cups 605. In this fashion, the safety clasps 608, 609 may be coaxial with the springs 604.

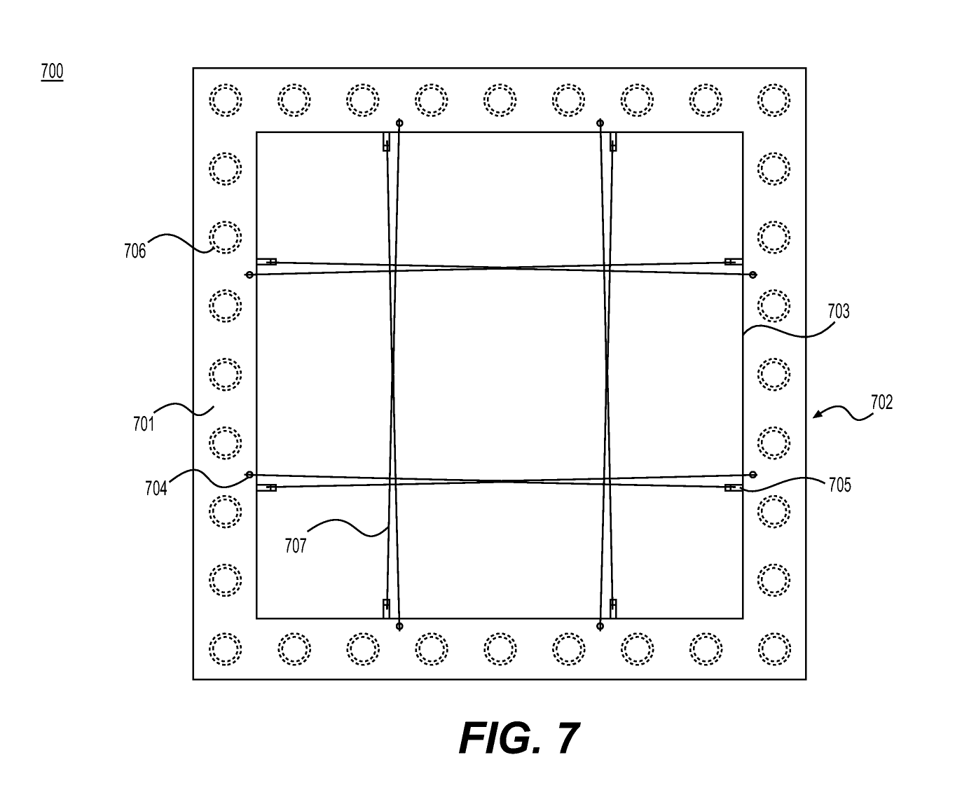

Turning now to FIG. 7, a top view of another embodiment vacuum insulated panel without the enclosure is illustrated. A frame 700 may be comprised of a first perimeter member 701, a second perimeter member (removed for clarity), a plurality of springs 706, a plurality of anchors 705, and a plurality of guy wires 707. Guy wires 707 may have a first end and a second end, whereby the first end may join to the first perimeter member 701 through anchor 705, and the second end may join to the second perimeter member 702 at point 704. By joining a plurality of guy wires in this fashion, the guy wires 707, being under tension, may prevent parallel translation of the perimeter members 701, 702, which may be in any planar direction parallel thereto, while maintaining thermal conductive isolation.

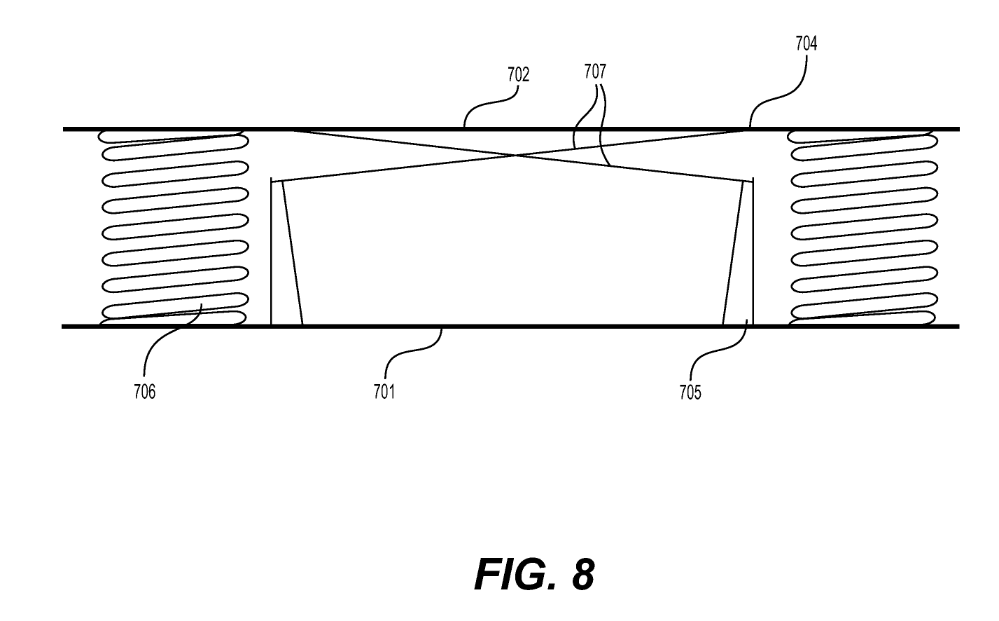

Referring now to FIG. 8, a sectioned, side view of a panel shown in FIG. 7 is illustrated. The guy wires 707 may now be more easily depicted to show diagonally crossing the central region and joining the first perimeter member 701 to the second perimeter member 702. The anchors 705 may be lengthened so the guy wires 707 need not pass through radiative baffles in order to simplify the intermediate layering process. The anchors 705 may be formed of suitable means, and attached to the first perimeter member 701 by suitable means, to accommodate strain from guy wire 707 tension.

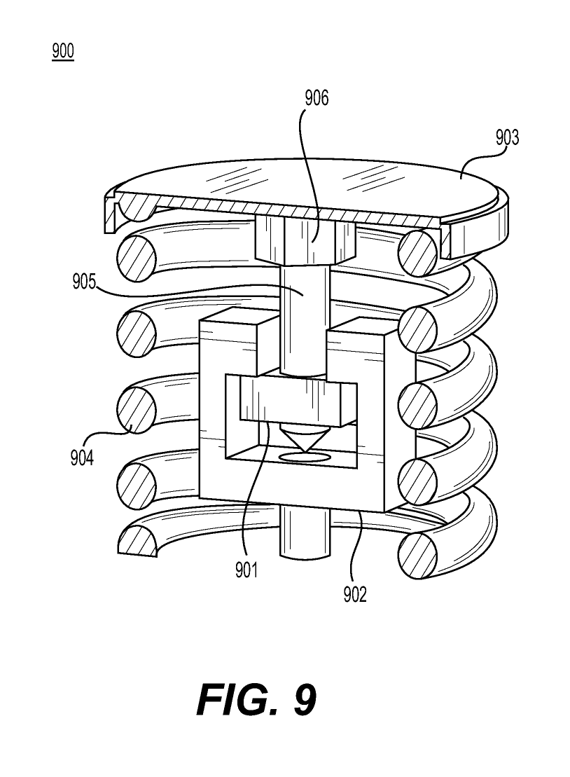

Referring now to FIG. 9, a perspective view of an embodiment safety clasp 900 is illustrated. The safety clasp 900 may comprise a clasp plug 901 and a clasp receptacle 902. The clasp plug 901 may comprise means for adjusting a height, such as a threaded rod 905 and a nut 906, prior to engagement with the clasp receptacle 902. The clasp plug 901 may laterally slide or rotate into the clasp receptacle 902 thereby engaging the safety mechanism. The clasp receptacle 902 may act to limit travel of the spring 904 if the clasp plug 901 engages the clasp receptacle 902, which may occur upon creating a vacuum within the panel 100 cavity. The safety clasp 900 may be coaxial with one or more springs 904 to make efficient use of space within the panel 100 cavity, to simplify manufacture, and/or to improve R-value. The safety clasp 900 may be attached to a plate 101,102, a frame 201, a cross-member 203, or a spring cup 903.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A thermally insulative sealed hollow panel, comprising:
a first plate disposed adjacent to a substantially parallel second plate;
a plurality of helically coiled springs with axes of compression that are substantially perpendicular to the plates and disposed therebetween, said axes being substantially equidistant from each other;
at least one layer of a low thermal emissivity film disposed between the plates and substantially parallel thereto, wherein the film engages the plurality of springs; and
a flexible perimeter edge membrane joined to at least one perimeter edge of the first plate and at least one perimeter edge of the second plate, thereby forming a closed cavity with a pressure between 0 and 1 atm.

2. The panel according to claim 1, further comprising a plurality of anchors joined to the first or second plate, each neighboring anchor being disposed substantially equidistant from each other.

3. The panel according to claim 3, further comprising at least one support wire engaging at least two of the plurality of anchors.

4. The panel according to claim 1, further comprising a plurality of clasps disposed between the plates, each clasp comprising a plug and a receptacle, wherein the plug is joined to the first plate and the receptacle is joined to the second plate, whereby the plug and the receptacle engage upon assembling the first plate with the second plate.

5. The apparatus according to claim 4, wherein the clasp plugs and clasp receptacles are not in conductive thermal communication.

6. The panel according to claim 1, wherein the thermal emissivity of the film is between 0 and 0.1.

7. The panel according to claim 1, wherein the closed cavity is held at a pressure between 0 and 0.05 atm, essentially producing a vacuum in the cavity.

8. The panel according to claim 1, wherein the closed cavity is at least partially filled with a gas having a specific heat between 0 and 1.0 kJ/kg·K at constant pressure.

9. The panel according to claim 1, wherein the membrane and plurality of springs are made of metal having a thermal conductivity between 0 and 20 W/m·K.

10. The panel according to claim 1, further comprising a first frame and a second frame, wherein the frames are disposed between the plates and substantially parallel thereto, and displaced from each other by the plurality of springs, and wherein the first frame is joined to the first plate and the second frame is joined to the second plate, each frame comprising at least one perimeter member and a plurality of cross members joined to the at least one perimeter member.

11. The panel according to claim 10, further comprising a plurality of guy wires joining the first frame and second frame, whereby each guy wire diagonally traverses a central region of the closed cavity and is under tension to prevent parallel translation of the frames.

12. A thermally insulative sealed hollow panel, comprising:
a support structure comprising,
1) a first frame disposed adjacent to a substantially parallel second frame, each frame having at least one perimeter member and a plurality of cross members,
2) a plurality of helically coiled springs with axes of compression that are substantially perpendicular to the frames with the springs disposed therebetween,
3) a plurality of guy wires, each guy wire having a first end and a second end, the first end being joined to the first plate and the second end being joined to the second plate, whereby the guy wires diagonally traverse a central region, and
4) at least one layer of low thermal emissivity film disposed between the frames and substantially parallel thereto, wherein the film engages at least one of the plurality of springs; and
an enclosure surrounding the support structure thereby creating a closed cavity with a pressure between 0 and 1 atm, wherein the enclosure is joined to the first frame and the second frame.

13. The panel according to claim 12, further comprising a plurality of anchors joined to the support structure and being evenly distributed along the at least one perimeter member of the first frame.

14. The panel according to claim 13, further comprising a plurality of support wires interconnected to the plurality of anchors wherein each support wire has a first end and a second end, the first end being tied to at least one anchor and the second end being tied to a corresponding opposite anchor so that the support wire spans the central region.

15. The panel according to claim 12, wherein the springs are joined to the at least one perimeter member and the plurality of cross members.

16. The panel according to claim 12, further comprising a plurality of clasps joined to the first frame and the second frame, each clasp comprising a plug and a receptacle, whereby the plug and the receptacle engage upon assembling the frames.

17. The panel according to claim 16, wherein the spring axes are substantially equidistant from each other.

18. The panel according to claim 12, wherein the enclosure and plurality of springs are made of metal having a thermal conductivity between 0 and 20 W/m·K.

19. A thermally insulative sealed hollow panel, comprising:
means for enclosing a vacuum sealable cavity, wherein the enclosing means comprise at least two substantially parallel sides and at least one flexible edge membrane;
means for spacing the two sides;
means for reducing radiative heat transfer between the two sides;
means for supporting the radiative heat transfer reducing means; and
means for anchoring the supporting means to the enclosing means, the anchoring means joined to at least one side of the enclosing means.

20. The panel according to claim 19, wherein the spacing means comprise helically coiled springs with a thermal conductivity between 0 and 20 W/m·K.
